(19) United States
(12) Patent Application Publication
(10) Pub. No.: US 2026/0136279 A1
(43) Pub. Date: May 14, 2026

(54) Wireless network operation method having power saving mechanism

(71) Applicant: REALTEK SEMICONDUCTOR CORPORATION, HSINCHU (TW)

(72) Inventors: ZHAO-MING LI, Suzhou (CN); MENG-ZHOU SHEN, Suzhou (CN); CUI DING, Suzhou (CN); YI-DONG HE, Suzhou (CN)

(21) Appl. No.: 19/367,235

(22) Filed: Oct. 23, 2025

(30) Foreign Application Priority Data
Nov. 13, 2024 (CN) 202411615794.2

(51) Int. Cl. H04W 52/02

(52) U.S. Cl. CPC H04W 52/0206

(57) ABSTRACT

A wireless network operation method having power saving mechanism is provided. Packet storage states of node apparatuses are retrieved by a root node apparatus from an access point apparatus. For each of the node apparatuses, a node packet storage state table indicating the packet storage states is configured and a beacon signal including the node packet storage state table is broadcasted in an independent periodic broadcast time. For each of the node apparatuses, the beacon signals are received and the node packet storage state table included by the beacon signal is analyzed to update the node packet storage state table. For each of the node apparatuses entering a sleep mode, a predetermined schedule is performed to wake up to perform a packet transmitting process when the packet storage state of any one of the node apparatuses and the child node apparatus thereof has a storage indication level.

### BACKGROUND OF THE INVENTION

### 1. Field of the Invention

The present invention relates to a wireless network operation method having a power saving mechanism.

### 2. Description of Related Art

A mesh network allows the transmission of data or control commands between network nodes by using a dynamic routing method. Such a network keeps the integrity of the connections among the nodes. When some nodes in the network topology malfunction or can not provide service, a new routing can be formed by using a leaping method to transmit the message to the target node.

Each of the node apparatuses may enter a sleep mode and inform an access point apparatus. Under such a condition, if the access point apparatus is scheduled to transmit packets to any one of the node apparatuses that enters the sleep mode, the access point apparatus wakes up such a node apparatus such that the packets can be received. However, when other node apparatuses between the node apparatus entering the sleep mode and the access point apparatus also enter the sleep mode, these node apparatuses may not be able to be woken up to transfer the packets.

### SUMMARY OF THE INVENTION

In consideration of the problem of the prior art, an object of the present invention is to supply a wireless network operation method having a power saving mechanism.

The present invention discloses a wireless network operation method having a power saving mechanism used in a mesh network system that includes steps outlined below. By a root node apparatus of a plurality of node apparatuses from an access point apparatus, a plurality of packet storage states of the node apparatuses are retrieved, wherein a storage indication level of each of the packet storage states indicates that the access point apparatus stores a to-be-accessed packet corresponding to one of the node apparatuses. Each of the node apparatuses is operated to be a first node apparatus such that the first node apparatus configures a node packet storage state table indicating the plurality of packet storage states of the first node apparatus and at least one child node apparatus of the first node apparatus and broadcasts a beacon signal including a node packet storage state table in an independent periodic broadcast time. Each of the node apparatuses is operated to be a second node apparatus such that the second node apparatus receives the beacon signal from each of a father node apparatus of the second node apparatus and at least one child node apparatus of the second node apparatus that operates to be the first node apparatus. The node packet storage state table comprised by the beacon signal is analyzed by the second node apparatus to update the node packet storage state table in the second node apparatus. The second node apparatus is woken up according to a predetermined schedule to perform a packet transmitting process when the second node apparatus enters a sleep mode and when one of the packet storage states of either the second node apparatus or the at least one child node apparatus of the second node apparatus has the storage indication level.

These and other objectives of the present invention will no doubt become obvious to those of ordinary skill in the art behind reading the following detailed description of the preferred embodiments that are illustrated in the various figures and drawings.

### BRIEF DESCRIPTION OF THE DRAWINGS

FIG. 1 illustrates a diagram of a mesh network system according to an embodiment of the present invention.

FIG. 2 illustrates a flow chart of a wireless network operation method having a power saving mechanism according to an embodiment of the present invention.

FIG. 3 illustrates a diagram of a node packet storage state table of the node apparatus according to an embodiment of the present invention.

FIG. 4 illustrates a timing assignment of the beacon signals of the node apparatuses in the mesh network system according to an embodiment of the present invention.

FIG. 5 illustrates a node sleep state table of the node apparatus according to an embodiment of the present invention.

### DETAILED DESCRIPTION OF THE PREFERRED EMBODIMENTS

An aspect of the present invention is to provide a wireless network operation method having a power saving mechanism to retrieve packet storage states from an access point apparatus through a root node apparatus such that each of node apparatuses configures a node packet storage state table to broadcast a beacon signal including the node packet storage state table for all the node apparatuses to receive the packet storage states. The node apparatuses that enter a sleep mode are woken up according to a predetermined schedule generated based on the packet storage states thereof and the packet storage states of the child node apparatus thereof to perform a packet transmitting process. The accuracy of the packet transmission can be increased.

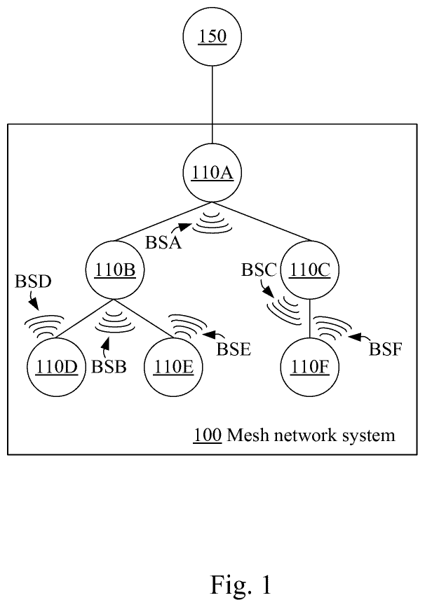

Reference is now made to FIG. 1. FIG. 1 illustrates a diagram of a mesh network system 100 according to an embodiment of the present invention. The mesh network system 100 includes the node apparatuses 110A˜110F.

The mesh network system 100 is a communication network having a mesh topology that allows the node apparatuses 110A˜110F to communication each other. Each of the node apparatuses 110A˜110F includes a processing circuit, a communication circuit and a storage circuit (not illustrated) to implement a computing apparatus that has an independent address and is able to transmit and receive data.

The node apparatuses 110A˜110F may communicate with an access point apparatus 150, wherein the node apparatus 110A that is directly connected to the access point apparatus 150 is a root node apparatus. The node apparatuses connected to the access point apparatus 150 through the root node apparatus are secondary node apparatuses, e.g., the node apparatus 110B and 110C connected to the node apparatus 110A in FIG. 1. The node apparatuses connected to the access point apparatus 150 through the secondary node apparatuses are tertiary node apparatuses, e.g., the node apparatuses 110D and 110E connected to the node apparatus 110B and the node apparatus 110F connected to the node apparatus 110C illustrated in FIG. 1. It is appreciated that the configuration and the number of the node apparatuses illustrated in FIG. 1 are merely an example. In other embodiments, the node apparatuses may be configured to have more layers. The present invention is not limited thereto.

In the configuration described above, for the node apparatuses at two consecutive layers that are connected, the node apparatus at the previous layer is the father node apparatus of the node apparatus at the subsequent layer, and the node apparatus at the subsequent layer is the child node apparatus of the node apparatus at the previous layer. For example, In FIG. 1, the node apparatus 110B is the father node apparatus of the node apparatus 110D and the node apparatus 110D is the child node apparatus of the node apparatus 110B. Any one of the node apparatuses has only one father node apparatus, while a father node apparatus is allowed to have a plurality of child node apparatuses.

Each of the node apparatuses 110A˜110F uses an assistance table stored therein to document the corresponding child node apparatuses and the child node apparatuses of these child node apparatuses. For example, the assistance table of the node apparatus 110B documents the node apparatuses 110D and 110E. The assistance table of the node apparatus 110C documents the node apparatus 110F. The assistance table of the node apparatus 110A documents the node apparatus 110B˜110F.

Each of the node apparatuses 110A˜110F may document the child node apparatuses by using related information of each of the child node apparatuses, such as but not limited to media access control (MAC) or a variants thereof (e.g., information generated by performing a hash value calculation or a circular redundancy check (CRC) calculation based on the media access control). Further, besides documenting the existence of these child node apparatuses, each of the node apparatuses 110A˜110F may also document the states of the child node apparatuses.

The detail of the network configuration and the establishment of the assistance table can be referred to US patent application US20240015585A1 and is not described herein. The node apparatuses 110A˜110F may form the configuration described above according to a pairing process, where the detail of the pairing process can be referred to US patent application US20240015822A1 and is not described herein.

Each of the node apparatuses 110A˜110F may enter a sleep mode when a certain criteria is met and notify the access point apparatus 150 about the condition of entering the sleep mode. Under such a condition, when the access point apparatus 150 has packets to be transmitted to any one of the node apparatuses 110A˜110F that enters the sleep mode, the access point apparatus 150 notifies the node apparatus that enters the sleep mode to wake up such that the packets can be received. However, when other node apparatuses between the node apparatus entering the sleep mode and the access point apparatus 150 also enter the sleep mode, these relay node apparatuses may not be able to be woken up to transfer the packets.

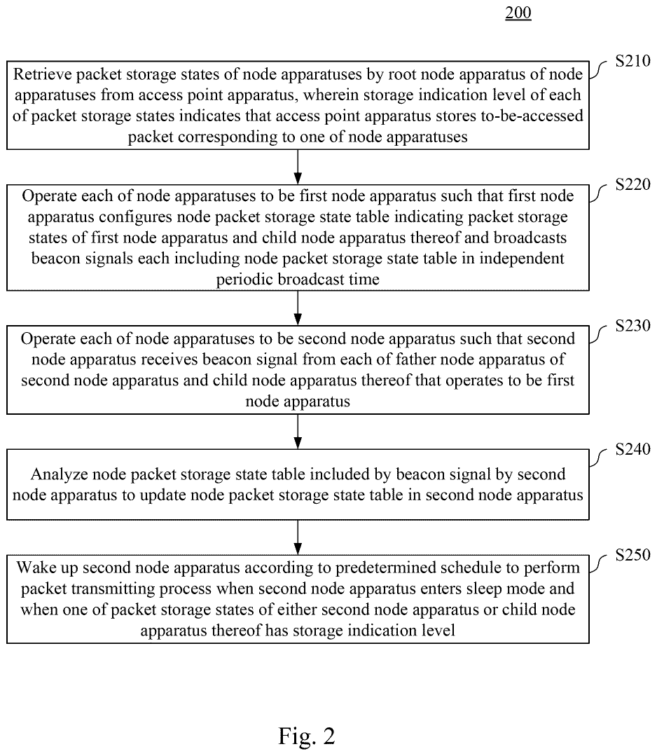

Reference is now made to FIG. 2. FIG. 2 illustrates a flow chart of a wireless network operation method 200 having a power saving mechanism according to an embodiment of the present invention. The wireless network operation method 200 can be used in the mesh network system 100 in FIG. 1 such that the node apparatuses that enter the sleep mode can be woken up to perform the packet transmission in an efficient way to maintain the stability of data transmission and power-saving at the same time.

In step S210, by a root node apparatus (i.e., the node apparatus 110A) of the node apparatuses 110A˜110F from the access point apparatus 150, a plurality of packet storage states of the node apparatuses are retrieved, wherein a storage indication level of each of the packet storage states indicates that the access point apparatus 150 stores a to-be-accessed packet corresponding to one of the node apparatuses.

Since the access point apparatus 150 stores the packets scheduled to be transmitted to all the node apparatuses in the sleep mode, the root node apparatus directly connected to the access point apparatus 150 can retrieve the packet storage states of all the node apparatuses from the access point apparatus 150.

In an embodiment, when the node apparatuses 110A˜110F join the mesh network system 100, the access point apparatus 150 assigns an independent association identification number (AID) to each of the node apparatuses 110A˜110F. For example, the node apparatuses 110A˜110F in turn have association identification numbers of 1˜6.

On the other hand, the access point apparatus 150 configures a storage indication level and a non-storage indication level to each of the packet storage states corresponding to any one of the node apparatuses 110A˜110F.

For example, when a packet storage state has the storage indication level (e.g., 1), the access point apparatus 150 stores at least one packet of the node apparatus corresponding to the packet storage state. When a packet storage states has the non-storage indication level (e.g., 0), the access point apparatus 150 does not store any packet of the node apparatus corresponding to the packet storage state.

As a result, the root node apparatus, according to the association identification number and the corresponding packet storage state provided by the access point apparatus 150, may identify whether the access point apparatus 150 has the packets to be retrieved by each of the node apparatuses 110A˜110F.

For example, when the root node apparatus retrieves an association identification number that is 3 and the corresponding packet storage state is the storage indication level, the condition that the access point apparatus 150 has at least one packet for the node apparatus 110C to retrieve is indicated.

In step S220, each of the node apparatuses 110A˜110F is operated to be a first node apparatus such that the first node apparatus configures a node packet storage state table indicating the plurality of packet storage states of the first node apparatus and at least one child node apparatus of the first node apparatus and broadcasts beacon signals BSA˜BSF each including a node packet storage state table in an independent periodic broadcast time.

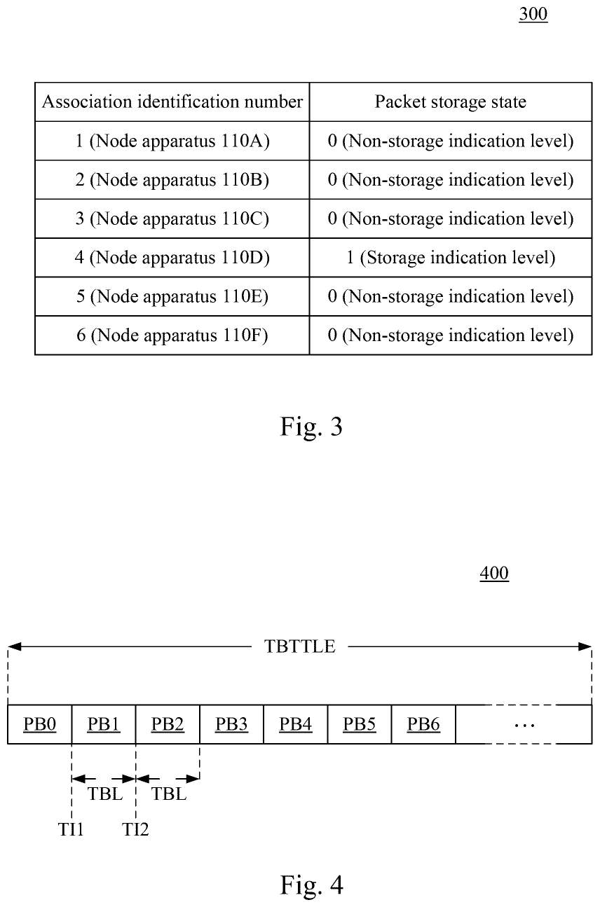

Reference is now made to FIG. 3. FIG. 3 illustrates a diagram of a node packet storage state table 300 of the node apparatus 110A according to an embodiment of the present invention.

In an embodiment, the node packet storage state table 300 documents the packet storage states corresponding to the first node apparatus and at least one child node apparatus of the first node apparatus by using the association identification numbers thereof. Take the node apparatus 110A as an example, the node packet storage state table 300 includes the association identification numbers, which are 1˜6, of the node apparatus 110A and the child node apparatuses including the node apparatuses 110B˜110F of the node apparatus 110A to respectively document the packet storage states of 0, 0, 0, 1, 0 and 0. Since the storage indication level is 1 and the non-storage indication level is 0, the node packet storage state table 300 in FIG. 3 indicates that the access point apparatus 150 only stores at least one packets for the node apparatus 110D to retrieve.

It is appreciated that for each of the other node apparatuses 110B˜110F, the number of the child node apparatuses is different and the number of the entries in the node packet storage state table thereof is different.

Reference is now made to FIG. 4. FIG. 4 illustrates a timing assignment of the beacon signals BSA˜BSF of the node apparatuses 110A˜110F in the mesh network system 100 according to an embodiment of the present invention.

In an embodiment, the mesh network system 100 assigns the timing of the beacon signals BSA˜BSF according to a target beacon transmission time (TBTT) 400 configured by the access point apparatus 150. A target beacon transmission time length TBTTLE of one target beacon transmission time 400 is such as, but not limited to 102.4 millisecond, where the target beacon transmission time 400 is equally divided into a plurality of beacon windows to dispose the periodic broadcast times of different node apparatuses. Each of the beacon windows may further include a plurality of unit times and the number of the unit times in a beacon window can be configured depending on practical requirements.

In the target beacon transmission time 400 in FIG. 4, the periodic broadcast times PB 1˜PB6 corresponding to the node apparatuses 110A˜110F are illustrated. Different numbers of the periodic broadcast times can be configured in the beacon windows of the target beacon transmission time 400 according to the actual number of the node apparatuses included in the mesh network system 100.

The periodic broadcast times PB1˜PB6 are assigned in the target beacon transmission time 400 according to association identification numbers of the node apparatuses 110A˜110F in the mesh network system 100.

The target beacon transmission time 400 further includes an initial periodic broadcast time PB0 that is an access point broadcast time for the access point apparatus 150 to broadcast the beacon signal. Take the periodic broadcast times PB1 and PB2 as example, each of the periodic broadcast times PB1 and PB2 has the same periodic broadcast time length TBL and respectively has a node broadcast initial time spot TI1 and a node broadcast initial time spot TI2.

Each of the beacon signals BSA˜BSF has a node packet storage state table that indicates the packet storage states of the first node apparatus and the at least one child node apparatus of the first node apparatus. For example, for the node apparatus 110A, the node apparatuses 110B and 110C are the child node apparatuses thereof and the node apparatuses 110D˜110F are the child node apparatuses of the node apparatuses 110B and 110C. As a result, the node packet storage state table in the beacon signal BSA broadcasted by the node apparatus 110A includes the packet storage states of the node apparatuses 110A˜110F.

In an embodiment, each of the beacon signals BSA˜BSF includes a plurality of entries to document the content of a media access control address header, a time stamp, a beacon time interval, a service set identifier, specific information and a frame check sequence (not illustrated in the figure). The specific information such as the node packet storage state table is documented in a vendor information element (vendor IE) entry of each of the beacon signals BSA˜BSF.

In some embodiments, the node packet storage state table is actually a part of the assistance table stored in each of node apparatuses. More specifically, the assistance table may store a plurality of states of at least one child node apparatus of a node apparatuses, including the packet storage states. Each of the node apparatuses retrieves the part corresponding to the node packet storage state table from the assistance table and fills the part to the corresponding entry of the beacon signal to be transmitted.

In step S230, each of the node apparatuses 110A˜110F is operated to be a second node apparatus such that the second node apparatus receives the beacon signal BSA˜BSF from each of a father node apparatus of the second node apparatus and at least one child node apparatus of the second node apparatus that operates to be the first node apparatus.

Take the node apparatus 110B as an example, the node apparatus 110B receives the beacon signals BSA, BSD and BSE from the node apparatus 110A that is the father node apparatus thereof and from the node apparatuses 110D and 100E that are the child node apparatuses thereof.

When the node apparatus 110B does not enter the sleep mode, the node apparatus 110B receives the beacon signals BSA, BSD and BSE according to the timing assignment illustrated in FIG. 3 at the periodic broadcast times PB1, PB4 and PB5 respectively. When the node apparatus 110B enters the sleep mode, the node apparatus 110B wakes up at the periodic broadcast times PB1, PB4 and PB5 to respectively receive the beacon signals BSA, BSD and BSE and goes back to the sleep mode in other time slots when a certain criteria is satisfied.

In step S240, the node packet storage state table included by the beacon signal is analyzed by the second node apparatus to update the node packet storage state table in the second node apparatus.

Take the node apparatus 110B as an example, since the node packet storage state table is a part of the assistance table of each of the node apparatuses, the node apparatus 110B may update the content in the assistance table thereof corresponding to the node packet storage state table after receiving and analyzing the beacon signal BSA of the node apparatus 110A. The packet storage states of 0, 0, 0, 1, 0 and 0 can be updated to the assistance table of the node apparatus 110B according to the association identification numbers 1˜6.

In step S250, the second node apparatus is woken up according to a predetermined schedule to perform a packet transmitting process when the second node apparatus enters a sleep mode and when one of the packet storage states of either the second node apparatus or the at least one child node apparatus of the second node apparatus has the storage indication level.

Take the node apparatus 110B as an example, the node apparatus 110B obtains the information that the access point apparatus 150 stores at least one packet of the node apparatus 110D according to the storage indication level of the packet storage state of the node apparatus 110D, which is the child node apparatus of the node apparatus 110B, from the beacon signal BSA of the node apparatus 110A.

When the node apparatus 110B does not enter the sleep mode, no other operation is required. The node apparatus 110B simply waits for the transmission of the at least one packet of the node apparatus 110D from the access point apparatus 150 and further performs the packet transmitting process to the node apparatus 110D. When the node apparatus 110B enters the sleep mode, the node apparatus 110B wakes up according to a predetermined schedule to perform the packet transmitting process.

In an embodiment, the predetermined schedule is to, when one of the packet storage states of the at least one child node apparatus of the second node apparatus has the storage indication level, directly wake up the second node apparatus or wake up the second node apparatus according to a scheduled wake-up time of the at least one child node apparatus of the second node apparatus to perform the packet transmitting process.

Take the node apparatus 110B as an example, when the packet storage state of the node apparatus 110D is determined to have the storage indication level, the node apparatus 110B that enters the sleep mode is directly woken up to perform the packet transmitting process until the packet transmitting process is finished.

In another embodiment, the predetermined schedule is to, when one of the packet storage states of the at least one child node apparatus of the second node apparatus has the storage indication level, wake up the second node apparatus according to a scheduled wake-up time of the at least one child node apparatus of the second node apparatus to perform the packet transmitting process.

Take the node apparatus 110B as an example, when the packet storage state of the node apparatus 110D is determined to have the storage indication level, the node apparatus 110B that enters the sleep mode is woken up according to the scheduled wake-up time of the node apparatus 110D to perform the packet transmitting process.

For example, when the beacon signal BSD transmitted by the node apparatus 110D includes a delivery traffic indication message (DTIM), the delivery traffic indication message may indicate that the node apparatus 110D is not woken up in every one of the target beacon transmission times 400 illustrated in FIG. 4 and is woken up in every certain number of periods DTIM_STA of the target beacon transmission times 400.

Take the number of periods of 5 (i.e., the apparatus is woken up every 5 target beacon transmission times 400) as an example, the node apparatus 110B, after receiving the beacon signal BSD, obtains a current time CU_TSF based on a time synchronization function (TSF), calculates a ratio between the current time CU_TSF and a length of the target beacon transmission time 400 (102.4 milliseconds, which is 102400 microseconds) and multiplies the ratio by the number of periods DTIM_STA to generate an index “INDEX”:

$$INDEX = ( CU\_TSF / 102400 ) \% DTIM\_STA \qquad ( equation 1 )$$

The symbol ‘%’ represents the modulo operation. The value of the index that is not 0 indicates that the node apparatus 110D is still in the sleep mode. Under such a condition, the node apparatus 110B is kept in the sleep mode and is woken up only when a beacon signal is required to be received. The value of the index that is 0 indicates that the node apparatus 110D is about to be woken up. Under such a condition, the node apparatus 110B is woken up to perform the packet transmitting process until the packet transmitting process is finished.

In yet another embodiment, the predetermined schedule is to, when one of the packet storage states of the at least one child node apparatus of the second node apparatus has the storage indication level, extend a wake-up time corresponding to an access point broadcast time to perform the packet transmitting process

Take the node apparatus 110B as an example, when the packet storage state of the node apparatus 110D is determined to have the storage indication level, besides being woken up in the initial periodic broadcast time PB0 serving as the access point broadcast time in FIG. 4, the node apparatus 110B extends the wake-up time to perform the packet transmitting process. Since all the node apparatuses 110A˜110F in the mesh network system 100 are woken up in the access point broadcast time, such a configuration can also make sure that each of the node apparatuses on the packet transmission path is woken up.

It is appreciated that in the embodiments described above, the condition that the node apparatus 110B performs updating and determines whether to be woken up or not according to the beacon signal BSA of the node apparatus 110A is used as an example. The node apparatuses 110C˜110E can use the same mechanism to receive the beacon signal of other node apparatuses to perform updating and determine whether to be woken up or not. In the embodiments described above, since only at least one packet of the node apparatus 110D is stored by the access point apparatus 150, only the node apparatus 110D needs to be woken up when the node apparatuses 110D˜110F all enter the sleep mode.

By using the method described above, once the access point apparatus 150 stores the packets of any one of the node apparatuses, the node apparatus 110A operating as the root node apparatus is able to retrieve the packet storage states and broadcasts the beacon signal BSA to be received by the node apparatuses 110B and 110C in the next layer to update the node packet storage state tables therein, determine whether to be woken up or not, and broadcast the beacon signals BSB and BSC. The node apparatuses 110D˜110F in the level next to the node apparatuses 110B and 110C receive the beacon signals BSB and BSC to update the node packet storage state tables therein and determine whether to be woken up or not.

In an embodiment, after the second node apparatus that enters the sleep mode is woken up according to the predetermined schedule, a wake-up notice signal is transmitted through a transmission path from the father node apparatus of the second node apparatus to the root node apparatus by the second node apparatus such that the root node apparatus further transmits the wake-up notice signal to the access point apparatus 150 to initiate the packet transmitting process by the access point apparatus.

Take the node apparatus 110B as an example, after the node apparatus 110B that enters the sleep mode is woken up according to the predetermined schedule, the wake-up notice signal is transmitted through the transmission path including the node apparatus 110A to the access point apparatus 150 by node apparatus 110B. Take the node apparatus 110D as an example, after the node apparatus 110D that enters the sleep mode is woken up according to the predetermined schedule, the wake-up notice signal is transmitted through the transmission path including the node apparatus 110B and the node apparatus 110A to the access point apparatus 150 by node apparatus 110D. The access point apparatus 150 may initiate the packet transmitting process after receiving the wake-up notice signal from each of the node apparatuses that is woken up.

As a result, the packet storage states can be transmitted from the root node apparatus level by level to all the node apparatuses 110A˜110F in the mesh network system 100. When any one of the node apparatuses is needed to be woken up, the node apparatuses in the previous levels are all woken up to guarantee that the packets can be transmitted and the condition that the packets cannot be transmitted due to any one of the node apparatuses in the previous levels still in the sleep mode can be prevented. The accuracy of the packet transmission can be maintained when the node apparatuses 110A˜110F in the mesh network system 100 enter the sleep mode to accomplish the power-saving mechanism.

In an embodiment, in order to further make sure the node apparatuses 110A˜110F can maintain the accuracy of the data transmission, each of the node apparatuses 110A˜110F may operate as a first node apparatus to configure a node sleep state table indicating a plurality of sleep states of the first node apparatus and the at least one child node apparatus of the first node apparatus and broadcast the beacon signals BSA˜BSF including the node sleep state table in the independent periodic broadcast time by the first node apparatus.

Each of the sleep states has either a sleep indication level or a non-sleep indication level. For example, the sleep indication level (e.g., 1) of the sleep state indicates that the node apparatus corresponding thereto enters the sleep mode. The non-sleep indication level (e.g., 0) of the sleep state indicates that the node apparatus corresponding thereto does not enter the sleep mode.

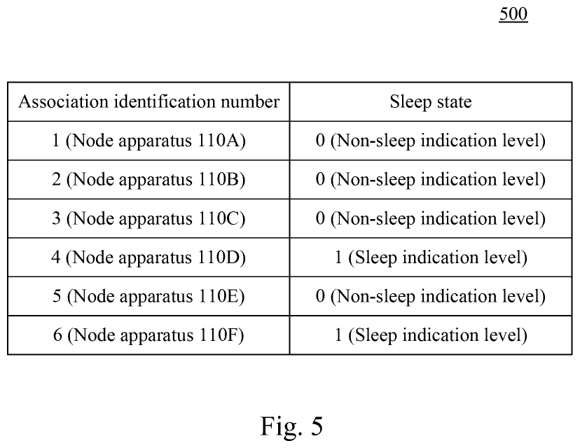

Reference is now made to FIG. 5. FIG. 5 illustrates a node sleep state table 500 of the node apparatus 110A according to an embodiment of the present invention.

In an embodiment, the node sleep state table 500 documents the sleep states corresponding to the association identification numbers of the first node apparatus and the at least one child node apparatus of the first node apparatus. Take the node apparatus 110A as an example, the node sleep state table 500 includes the association identification numbers of association identification number and the child node apparatuses thereof, which are the node apparatuses 110B˜110F, that are 1˜6 respectively. The node sleep state table 500 further documents the sleep states that are 0, 0, 0, 1, 0 and 1 corresponding to the association identification numbers described above. Since the sleep indication level is 1 and the non-sleep indication level is 0, the node sleep state table 500 in FIG. 5 indicates that only the node apparatus 110D and the node apparatus 110F enter the sleep mode.

It is appreciated that for each of the other node apparatuses 110B˜110F, the number of the child node apparatuses is different and the number of the entries in the node sleep state table thereof is different.

In some embodiments, the node sleep state table is actually a part of the assistance table stored in each of node apparatuses. More specifically, the assistance table may store a plurality of states of at least one child node apparatus of a node apparatuses, including the sleep states. Each of the node apparatuses retrieves the part corresponding to the node sleep state table from the assistance table and fills the part to the corresponding entry of the beacon signal to be transmitted.

Each of the node apparatuses 110A˜110F may operate to be the second node apparatus to determine whether to enter the sleep mode or not according to the at least one child node apparatus of the second node apparatus.

In an embodiment, the second node apparatus does not enter the sleep mode to be kept awake when the sleep state of any one of the at least one child node apparatus is not the sleep indication level. For example, though the sleep state of the node apparatus 110D is the sleep indication level such that the node apparatus 110D enters the sleep mode, the sleep state of the node apparatus 110E is the non-sleep indication level such that the node apparatus 110E does not enter the sleep mode. As a result, the node apparatuses 110A and 110B having these child node apparatuses need to be kept awake.

On the other hand, the second node apparatus enters the sleep mode when the sleep state of all the at least one child node apparatus is the sleep indication level.

For example, under the condition that the sleep state of the node apparatus 110F is the sleep indication level such that the node apparatus 110F enters the sleep mode and the node apparatus 110C only has such a child node apparatus, the node apparatus 110C can also enter the sleep mode.

By using the mechanism described above, the node apparatuses 110A˜110F may determine whether to enter the sleep mode according to the sleep state of the at least one child node apparatus thereof to keep the accuracy of the data transmission.

In an embodiment, the clock signals that the node apparatuses 110A˜110F operate accordingly may become unsynchronized. In order to keep the timings of the node apparatuses 110A˜110F synchronized to broadcast the beacon signals BSA˜BSF precisely at the scheduled timings, each of the node apparatuses 110A˜110F operating to be the first node apparatus may broadcast the beacon signals BSA˜BSF each including the association identification number of the first node apparatus.

Each of the node apparatuses 110A˜110F operates to be the second node apparatus to receive the beacon signals BSA˜BSF, such that the second node apparatus retrieves, from the beacon signal of the father node apparatus of the second node apparatus, a father node broadcast initial time spot of the periodic broadcast time of the father node apparatus. Take the node apparatus 110B as an example, the node apparatus 110B retrieves, from the beacon signal BSA of the node apparatus 110A that is the father node apparatus of the node apparatus 110B, the periodic broadcast time of the node apparatus 110A, e.g., the node broadcast initial time spot TI1 of the periodic broadcast time PB1 in FIG. 4.

The second node apparatus calculates a node broadcast initial time spot of the second node apparatus in the periodic broadcast time according to a periodic broadcast time length the father node broadcast initial time spot, the association identification number of the second node apparatus, the association identification number of the father node apparatus of the second node apparatus and periodic broadcast time length.

Take the node apparatus 110B as an example, the node apparatus 110B, according to the node broadcast initial time spot TI1 of the periodic broadcast time PB1, the association identification number AID2 of the node apparatus 110B itself, the association identification number AID1 of the node apparatus 110A and the periodic broadcast time length TBL, calculates the node broadcast initial time spot TI2 of the periodic broadcast time PB2 by using the equation below:

$$TI 2 = AID 2 \times TBL = ( AID 2 - AID 1 ) \times TBL + TI 1 \qquad ( equation 2 )$$

On the other hand, the second node apparatus calculates a child node broadcast initial time spot of the at least one child node apparatus of the second node apparatus in the periodic broadcast time according to the node broadcast initial time spot, the association identification number of the at least one child node apparatus of the second node apparatus and the periodic broadcast time length.

Take the node apparatus 110A that is the father node apparatus of the node apparatus 110B as an example, the node broadcast initial time spot TI2 of the node apparatus 110B can also be calculated according to the following equation:

$$TI 2 = AID 2 \times TBL = TI 1 + ( AID 2 - AID 1 ) \times TBL \qquad ( equation 3 )$$

By using the method described above, any one of the node apparatuses 110A˜110F in the mesh network system 100 may calculate the node broadcast initial time spot thereof according to the node broadcast initial time spot of the father node apparatus thereof after the transmission and receiving of the beacon signals BSA˜BSF, and further the node broadcast initial time spot of the at least one child node apparatus thereof. The timings of the whole mesh network system 100 can be synchronized.

It is appreciated that the embodiments described above are merely an example. In other embodiments, it should be appreciated that many modifications and changes may be made by those of ordinary skill in the art without departing, from the spirit of the disclosure.

In summary, the present invention discloses the wireless network operation method having a power saving mechanism to retrieve packet storage states from an access point apparatus through a root node apparatus such that each of node apparatuses configures a node packet storage state table to broadcast a beacon signal including the node packet storage state table for all the node apparatuses to receive the packet storage states. The node apparatuses that enter a sleep mode are woken up according to a predetermined schedule generated based on the packet storage states thereof and the packet storage states of the child node apparatus thereof to perform a packet transmitting process. The accuracy of the packet transmission can be increased.

The aforementioned descriptions represent merely the preferred embodiments of the present invention, without any intention to limit the scope of the present invention thereto. Various equivalent changes, alterations, or modifications based on the claims of present invention are all consequently viewed as being embraced by the scope of the present invention.

What is claimed is:

1. A wireless network operation method having a power saving mechanism used in a mesh network system, comprising:
retrieving, by a root node apparatus of a plurality of node apparatuses from an access point apparatus, a plurality of packet storage states of the node apparatuses, wherein a storage indication level of each of the packet storage states indicates that the access point apparatus stores a to-be-accessed packet corresponding to one of the node apparatuses;
operating each of the node apparatuses to be a first node apparatus such that the first node apparatus configures a node packet storage state table indicating the plurality of packet storage states of the first node apparatus and at least one child node apparatus of the first node apparatus and broadcasts a beacon signal comprising a node packet storage state table in an independent periodic broadcast time;
operating each of the node apparatuses to be a second node apparatus such that the second node apparatus receives the beacon signal from each of a father node apparatus of the second node apparatus and at least one child node apparatus of the second node apparatus that operates to be the first node apparatus;
analyzing the node packet storage state table comprised by the beacon signal by the second node apparatus to update the node packet storage state table in the second node apparatus; and
waking up the second node apparatus according to a predetermined schedule to perform a packet transmitting process when the second node apparatus enters a sleep mode and when one of the packet storage states of either the second node apparatus or the at least one child node apparatus of the second node apparatus has the storage indication level.

2. The wireless network operation method of claim 1, wherein the predetermined schedule is to, when one of the packet storage states of the at least one child node apparatus of the second node apparatus has the storage indication level, directly wake up the second node apparatus or wake up the second node apparatus according to a scheduled wake-up time of the at least one child node apparatus of the second node apparatus to perform the packet transmitting process.

3. The wireless network operation method of claim 1, wherein the predetermined schedule is to, when one of the packet storage states of the at least one child node apparatus of the second node apparatus has the storage indication level, extend a wake-up time corresponding to an access point broadcast time to perform the packet transmitting process.

4. The wireless network operation method of claim 1, further comprising:
after the second node apparatus that enters the sleep mode is woken up according to the predetermined schedule, transmitting a wake-up notice signal through a transmission path from the father node apparatus of the second node apparatus to the root node apparatus by the second node apparatus such that the root node apparatus further transmits the wake-up notice signal to the access point apparatus to initiate the packet transmitting process by the access point apparatus.

5. The wireless network operation method of claim 1, wherein the periodic broadcast time is assigned in a target beacon transmission time (TBTT) according to an association identification number (AID) of each of the node apparatuses in the mesh network system, and an initial periodic broadcast time of the target beacon transmission time is an access point broadcast time.

6. The wireless network operation method of claim 5, wherein the beacon signal further comprises the association identification number of the first node apparatus, the wireless network operation method further comprising:
retrieving, from the beacon signal of the father node apparatus of the second node apparatus, a father node broadcast initial time spot of the periodic broadcast time of the father node apparatus by the second node apparatus;
calculating a node broadcast initial time spot of the second node apparatus in the periodic broadcast time by the second node apparatus according to a periodic broadcast time length the father node broadcast initial time spot, the association identification number of the second node apparatus, the association identification number of the father node apparatus of the second node apparatus and periodic broadcast time length; and
calculating a child node broadcast initial time spot of the at least one child node apparatus of the second node apparatus in the periodic broadcast time by the second node apparatus according to the node broadcast initial time spot, the association identification number of the at least one child node apparatus of the second node apparatus and the periodic broadcast time length.

7. The wireless network operation method of claim 5, wherein the node packet storage state table is documented in a vendor information element (vendor IE) entry of the beacon signal, and the node packet storage state table documents each of the plurality of packet storage states corresponding to the association identification number of each of the first node apparatus and the at least one child node apparatus of the first node apparatus.

8. The wireless network operation method of claim 1, further comprising:
configuring a node sleep state table indicating a plurality of sleep states of the first node apparatus and the at least one child node apparatus of the first node apparatus and broadcasting the beacon signal comprising the node sleep state table in the independent periodic broadcast time by the first node apparatus, wherein a sleep indication level of each of the plurality of sleep states indicates that a corresponding node apparatus enters the sleep mode;
analyzing the node sleep state table in the beacon signal by the second node apparatus to update the node sleep state table of the second node apparatus; and
determining whether the second node apparatus enters the sleep mode by the second node apparatus according to the sleep state of the at least one child node apparatus of the second node apparatus.

9. The wireless network operation method of claim 8, further comprising:
not entering the sleep mode to be kept awake by the second node apparatus when the sleep state of any one of the at least one child node apparatus is not the sleep indication level; and
entering the sleep mode by the second node apparatus when the sleep state of all the at least one child node apparatus is the sleep indication level.

10. The wireless network operation method of claim 1, wherein the node sleep state table is documented in a vendor information element entry of the beacon signal.
